(19) United States
(12) Patent Application Publication
(10) Pub. No.: US 2018/0287413 A1
(43) Pub. Date: Oct. 4, 2018

(54) WIRELESS CHARGING DEVICE ALIGNMENT GUIDING METHOD AND DEVICE AND SYSTEM FOR SAME

(71) Applicant: LG INNOTEK CO., LTD., Seoul (KR)

(72) Inventor: Woo Kil JUNG, Seoul (KR)

(73) Assignee: LG INNOTEK CO., LTD., Seoul (KR)

(21) Appl. No.: 15/766,774

(22) PCT Filed: Sep. 19, 2016
(86) PCT No.: PCT/KR2016/010395

§ 371 Date: Apr. 6, 2018

(30) Foreign Application Priority Data
Oct. 7, 2015 (KR) 10-2015-0140762

(51) Int. Cl. H02J 7/02; H02J 5/00; H02J 50/90; H02J 50/40; H01F 38/14

(52) U.S. Cl. CPC H02J 7/025; H02J 5/005; H04M 2201/38; H02J 50/40; H01F 38/14; H02J 50/90

(57) ABSTRACT

The present invention relates to a wireless charging device alignment guiding method and a device and system for same. A wireless charging device that receives power through a receiving coil from a wireless power transmitter provided with a transmitting coil, when the reception of power through the receiving coil is detected, may comprises: a power sensor for measuring the intensity of received power; a coil arranged state determining member for determining the current arranged states of the transmitting coil and the receiving coil on the basis of the measured power intensity; a device control member for generating a coil arrangement screen corresponding to the determined current arranged state; and a display member for outputting the generated coil arrangement screen. Accordingly, the present invention has the advantage of being able to effectively guide the position of a wireless charging device to where charging efficiency is optimal.

### TECHNICAL FIELD

The present invention relates to wireless charging, and more particularly, to a method of guiding alignment of a wireless charging device capable of guiding a charging area position having optimal wireless charging efficiency to be intuitively recognized and an apparatus and system therefor.

### BACKGROUND ART

Recently, in accordance with the rapid development of information and communication technologies, ubiquitous society is realized based on the information and communication technologies.

In order to access IT devices at anytime and anywhere, it is necessary to install sensors in which a computer chip equipped with a communication function is embedded in all social facilities. An issue of supplying power provided to the devices and the sensors is becoming a new challenge. As a type of a portable device such as a smartphone, a Bluetooth handset, a music player (e.g., iPod), and the like is rapidly increasing, recharging a battery requires time and effort for a user. As a solution for the problem, a wireless power transmission technology is recently getting a spotlight.

Wireless power transmission technology (or wireless energy transfer technology) corresponds to a technology that enables a transmitter to wirelessly transmit electrical energy to a receiver using a magnetic field induction principle. In the 1800s, it has already started to use an electric motor or a transformer using electromagnetic induction principle. Thereafter, a method of transmitting electric energy by emitting an electromagnetic wave such as a radio wave or laser has been attempted. A frequently used electric toothbrush or a wireless shaver is charged based on the electromagnetic induction principle.

Currently, a wireless energy transfer method is mainly classified into an electromagnetic induction method, an electromagnetic resonance method, and an RF transmission method using a short wavelength radio frequency.

According to the electromagnetic induction method, when two coils are adjacent to each other, if a current flows through one coil, magnetic flux is generated and the magnetic flux causes electromotive force on another coil. The electromagnetic induction method is rapidly deployed on a commercial scale centering on a hand-held device such as a cellular phone. The electromagnetic induction method can transmit power as much as maximum several hundred kilowatt (kW) and has high efficiency. However, since maximum transmission length is equal to or less than 1 cm, the electromagnetic induction method has a demerit in that it is necessary to place a device near a charger or a floor in general.

The electromagnetic resonance method has a characteristic that uses an electromagnetic field or a magnetic field rather than an electromagnetic wave or a current. Since the electromagnetic resonance method is nearly impervious to an electromagnetic wave problem, the electromagnetic resonance method has a merit in that it is safe to use the electromagnetic resonance method for a different electronic device or a human body. On the other hand, the electromagnetic resonance method has a demerit in that the method is used in a confined distance and space only and has a little bit lower energy transfer efficiency.

The short wavelength wireless power transmission method—simply, RF transmission method—utilizes a point that energy is directly transmitted and received in a radio wave form. This technology corresponds to a wireless power transmission method of an RF scheme using a rectenna. The rectenna is a mixed word using antenna and rectifier. The rectenna corresponds to an element configured to covert RF power into direct current power. In particular, the RF method is a technology that converts AC radio wave into DC. Recently, efficiency of the RF method is increased and ongoing effort to commercialize the RF method is actively performed.

A wireless power transmission technology can be utilized not only for mobile industry but also for IT, railroad, car, home appliance industry, and the like.

In general, since a transmitting coil configured to transmit wireless power is not exposed to the exterior of a wireless power transmitter, it is difficult for a user using a device to precisely check a position of the transmitting coil with the naked eye. Hence, when the user places a wireless charging device on a charging pad, it is difficult for the user to precisely recognize a position of the charging pad where charging efficiency is high.

And, a position of a receiving coil mounted on a wireless charging device varies depending on a kind and a type of a device and a user is unable to precisely recognize a positon of the receiving coil with the naked eye.

According to the related art, charging efficiency is rapidly changed according to the intensity of arrangement of a receiving coil of a wireless charging device and a transmitting coil of a wireless power transmitter. And, it is difficult for a user to intuitively check whether or not a wireless charging device is accurately placed on a charging pad.

### DISCLOSURE OF THE INVENTION

### Technical Tasks

Accordingly, the present invention is designed to substantially obviate problems due to limitations and disadvantages of the related art. An object of the present invention is to provide a method of guiding alignment of a wireless charging device and an apparatus and system therefor.

Another object of the present invention is to provide a method of guiding alignment of a wireless charging device capable of guiding an optimal position of the wireless charging device via a screen and an apparatus and system therefor.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

The present invention provides a method of guiding alignment of a wireless charging device and an apparatus and system therefor.

To achieve these and other advantages and in accordance with the purpose of the present invention, as embodied and broadly described, according to one embodiment, a wireless charging device receiving power from a wireless power transmitter equipped with a transmitting coil via a receiving coil can include, if power reception is sensed via the receiving coil, a power sensor configured to measure strength of reception power, a coil alignment state determining member configured to determine a current alignment state of the transmitting coil and the receiving coil based on the strength of the measured power, a device controller configured to generate a coil arrangement screen corresponding to the determined current alignment state, and a display member configured to display the generated coil arrangement screen.

The wireless charging device further includes a rectifier configured to convert AC power received via the receiving coil into DC power. In this case, the power sensor can measure strength of output voltage of the rectifier.

If the strength of the output voltage of the rectifier is equal to or less than a prescribed reference value, the device controller can control a prescribed guide message indicating a movement of the wireless charging device to be displayed via the display member.

The wireless charging device can further include a sensing member configured to sense a movement and a current position of the wireless charging device, and an optimal moving direction determining member configured to determine an optimal moving direction of the wireless charging device to align the transmitting coil with the receiving coil based on a change of the strength of the reception power according to the movement.

The device controller can control a prescribed direction indicator indicating the determined optimal moving direction to be displayed on a side of a screen.

The device controller calculates charging efficiency corresponding to the strength of the reception power and can control at least one of the calculated charging efficiency and the strength of the reception power to be displayed on a side of a screen.

The wireless charging device can further include a modulation/demodulation member configured to receive information for identifying a type of the wireless power transmitter and a coil arrangement information database configured to maintain arrangement form information of the transmitting coil according to a type of the wireless power transmitter.

The wireless charging device can further include a wireless communication member configured to receive arrangement form information of the transmitting coil from a prescribed server according to the type of the wireless power transmitter.

In this case, the device controller receives arrangement form information of the receiving coil corresponding to the type of the wireless charging device from the server via the wireless communication member and can store the arrangement form information of the receiving coil in the coil arrangement information database.

If charging efficiency calculated according to the strength of the reception power is equal to or greater than a prescribed reference value, the device controller can control prescribed information indicating that the transmitting coil is successfully aligned with the receiving coil to be displayed on a screen.

To further achieve these and other advantages and in accordance with the purpose of the present invention, according to a different embodiment, a wireless charging device receiving power from a wireless power transmitter equipped with a transmitting coil can include a wireless power receiver including a receiving coil receiving AC power from the transmitting coil and a rectifier configured to convert the AC power received via the receiving coil into DC power, a sensing member configured to sense a movement of the wireless charging device, if the measured strength of the rectifier output power is equal to or less than a prescribed reference value, an optimal moving direction determining member configured to determine an optimal moving direction of the wireless charging device based on a change of the strength of the rectifier output power according to the movement of the wireless charging device, and a display member configured to output information on the determined optimal moving direction.

To further achieve these and other advantages and in accordance with the purpose of the present invention, according to a further different embodiment, a method of guiding alignment in a wireless charging device configured to receive power from a wireless power transmitter equipped with a transmitting coil via a receiving coil, includes the steps of, if power reception is sensed via the receiving coil, measuring strength of reception power, determining a current alignment state of the transmitting coil and the receiving coil based on the strength of the measured power, and generating a coil arrangement screen corresponding to the determined current alignment state and displaying the coil arrangement screen on a screen.

The method can further include the step of converting AC power received via the receiving coil into DC power. In this case, the strength of the reception power may correspond to strength of the converted DC power.

In this case, if the strength of the converted DC power is equal to or less than a prescribed reference value, the method can further include the step of generating a prescribed guide message indicating a movement of the wireless charging device and displaying the prescribed guide message on the screen.

The method can further include the steps of sensing a movement and a current position of the wireless charging device and determining an optimal moving direction of the wireless charging device to align the transmitting coil with the receiving coil based on a change of the strength of the reception power according to the movement.

In this case, a prescribed direction indicator indicating the determined optimal moving direction can be displayed on a side of the screen.

The method can further include the step of calculating charging efficiency corresponding to the strength of the reception power. In this case, at least one of the calculated charging efficiency and the strength of the measured power can be displayed on a side of the screen.

The method can further include the steps of receiving prescribed transmitter type identification information from the wireless power transmitter and identifying a form of the transmitting coil arranged on a charging bed based on the transmitter type identification information.

The method can further include the step of receiving arrangement form information of the receiving coil corresponding to the type of the wireless charging device from a prescribed server and storing the arrangement form information of the receiving coil in the coil arrangement information database.

If charging efficiency calculated according to the strength of the reception power is equal to or greater than a prescribed reference value, the method can further include the step of displaying prescribed information indicating that the transmitting coil is successfully aligned with the receiving coil on a side of the screen.

To further achieve these and other advantages and in accordance with the purpose of the present invention, according to a further different embodiment, a method of guiding alignment in a wireless charging device configured to receive power from a wireless power transmitter equipped with a transmitting coil via a receiving coil, includes the steps of, if power reception is sensed via the receiving coil, measuring strength of rectifier output power, if the measured strength of the rectifier output power is equal to or less than a prescribed reference value, determining an optimal moving direction of the wireless charging device based on a change of the strength of the rectifier output power according to a movement of the wireless charging device, and displaying the determined optimal moving direction on a screen.

To further achieve these and other advantages and in accordance with the purpose of the present invention, according to a further different embodiment, it is able to provide a computer-readable recording media so as to read a program for executing a method among the methods of guiding alignment in the wireless charging device.

The embodiments of the present invention are just a part of preferred embodiments of the present invention. And, various embodiments to which technical characteristics of the present invention are reflected can be clearly induced and understood from the following description by those having ordinary skill in the technical field to which the present invention pertains.

### ADVANTAGEOUS EFFECTS

Accordingly, the present invention provides the following effects or advantages.

According to the present invention, it is able to provide a method of guiding alignment of a wireless charging device and an apparatus and system therefor.

According to the present invention, it is able to provide a method of guiding alignment of a wireless charging device capable of guiding an optimal position of the wireless charging device via a screen and an apparatus and system therefor.

According to the present invention, it is able to minimize power waste by maximizing wireless charging efficiency.

According to the present invention, it is able to provide a method of guiding alignment of a wireless charging device capable of adaptively guiding an optimal position according to a type of the wireless charging device and a type of a wireless power transmitter and an apparatus and system therefor.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram for a configuration of a wireless charging system according to one embodiment of the present invention;

FIG. 2 is a block diagram for explaining a structure of a wireless charging device according to one embodiment of the present invention;

FIG. 3 is a block diagram for explaining a structure of a wireless charging device according to a different embodiment of the present invention;

FIG. 4 is a diagram for explaining a transmitting coil arrangement structure of a wireless power transmitter according to one embodiment of the present invention;

FIG. 5 is a diagram for explaining a receiving coil arrangement structure of a wireless charging device according to one embodiment of the present invention;

FIG. 6 is a diagram for explaining a change of output voltage of a rectifier according to the intensity of arrangement of a transmitting coil and a receiving coil according to one embodiment of the present invention;

FIG. 7 is a diagram for explaining a method of guiding arrangement of a wireless charging device via a screen according to one embodiment of the present invention;

FIG. 8 is a diagram for explaining a method of guiding arrangement of a wireless charging device via a screen according to a different embodiment of the present invention;

FIG. 9 is a flowchart for explaining a method of guiding arrangement of a wireless charging device in the wireless charging device according to one embodiment of the present invention;

FIG. 10 is a flowchart for explaining a method of guiding arrangement of a wireless charging device in the wireless charging device according to a different embodiment of the present invention;

FIG. 11 is a flowchart for explaining a method of guiding arrangement of a wireless charging device in the wireless charging device according to a further different embodiment of the present invention.

### BEST MODE

According to a first embodiment of the present invention, a wireless charging device receiving power from a wireless power transmitter equipped with a transmitting coil via a receiving coil can include, if power reception is sensed via the receiving coil, a power sensor configured to measure strength of reception power, a coil alignment state determining member configured to determine a current alignment state of the transmitting coil and the receiving coil based on the strength of the measured power, a device controller configured to generate a coil arrangement screen corresponding to the determined current alignment state, and a display member configured to display the generated coil arrangement screen.

### Mode for Invention

In the following, a device to which embodiments of the present invention are applied and various methods are explained in more detail with reference to the accompanying drawings. In general, a suffix such as “module” and “member” may be used to refer to elements or components. Use of such a suffix herein is merely intended to facilitate description of the specification, and the suffix itself is not intended to give any special meaning or function.

In the above, although it is explained as all configuration elements constructing embodiments of the present invention are combined by one or operate in a manner of being combined, the present invention is not restricted to the embodiments. In particular, all configuration elements may operate in a manner of being selectively combined using one or more configuration elements within the scope of the present invention. Although it is able to implement each of the configuration elements as independent hardware, all or a part of the configuration elements can be implemented as a computer program having a program module configured to perform all or a part of functions of a plurality of hardware by selectively combining all or a part of the configuration elements. Codes and code segments constructing the computer program can be easily inferred by those skilled in the art of the technical field to which the present invention belongs thereto. The computer program is stored in a computer-readable media and is read and executed by a computer to implement the embodiment of the present invention. The computer readable media of the computer program can include a magnetic recording media, an optical recording media, and the like.

When an embodiment is explained, if it is described as configuration elements are formed at the “top (above) or bottom (below)” and “fore (front) or latter (back)”, the “top (above) or bottom (below)” and the “fore (front) or latter (back)” include both a case that two configuration elements are directly contacted and a case that one or more different configuration elements are deployed between the two configuration elements.

Such a term as “include”, “configure”, or “has” means that a corresponding configuration element is embedded unless there is a special citation and should be construed that a different configuration element is further included rather than the different configuration element is excluded. All terminologies including a technical terms or a scientific term have a meaning identical to a meaning generally understood by those skilled in the art to which the present invention belongs thereto. Similar to a term defined in a dictionary, it is necessary to comprehend generally used terms as terms matched with a meaning of the context of the related art. Unless a term is explicitly defined in the present invention, the term is not interpreted as an ideal meaning or an excessively formal meaning.

When configuration elements of the present invention are described, it may use such terms as first, second, A, B, (a), (b), and the like. These terms are generally only used to distinguish one element from another. Nature, order, and the like of a corresponding configuration element are not restricted by the terms. It will be understood that when a configuration element is referred to as being “connected with”, “combined with”, or “access” a different configuration element, the configuration element can be directly connected with the different configuration element. Or, it will be understood that a further different configuration element is “connected with”, “combined with”, or “access” between configuration elements.

When the embodiments of the present invention are described, for clarity, a device configured to transmit wireless power in a wireless power supply system may be referred to as a wireless power transmitter, a wireless power transmission device, a wireless power transmission apparatus, a transmitting end, a transmission device, a transmitting side, and the like in a manner of being mixed.

And, for clarity, a device configured to receive wireless power from a wireless power transmission device may be referred to as a wireless power receiver, a wireless power reception device, a wireless power reception apparatus, a receiving end, a reception device, a receiving side, and the like in a manner of being mixed.

A wireless charging device on which a wireless power receiver configured to wirelessly receive power from a wireless power transmitter is mounted can include a mobile phone, a smartphone, a laptop computer, a digital broadcasting terminal, a PDA (personal digital assistants), a PMP (portable multimedia player), a navigator, various wearable devices including a smart watch, and the like, by which the present invention may be non-limited. If a device is equipped with a means for receiving wireless power and guiding arrangement of a device and is capable of charging a battery, the device may satisfy the wireless charging device described in the present specification. According to a different embodiment of the present invention, a wireless charging device can be mounted on a vehicle, an unmanned aerial vehicle, an air drone, a home appliance, and the like.

A wireless charging device according to one embodiment of the present invention can also include a communication means for performing communication with a server connected with a network. In this case, a communication network used for performing communication with the server may correspond to a mobile communication network to which such mobile communication standards as WCDMA (Wideband Code Division Multiple Access), LTE (Long Term Evolution)/LTE-Advanced, and the like are applied, by which the present invention may be non-limited. The communication network can also include a wireless internet communication network such as Wi-Max/Wi-Fi.

Basically, a wireless power transmitter according to the present invention may have a pad form, by which the present invention may be non-limited. According to a different embodiment, the wireless power transmitter may have a form such as a cradle, an AP (access point), a small base station, a stand, a form buried in ceiling, a wall-mounted form, a form buried in vehicle, a form mounted on vehicle, and the like. A wireless power transmitter can transmit power to a plurality of wireless power reception devices, i.e., wireless charging devices, at the same time.

To this end, the wireless power transmitter may provide at least one wireless power transmission scheme, e.g., electromagnetic induction scheme, electromagnetic resonance scheme, etc.

For example, a wireless power transmission scheme may use various wireless power transmission standards based on an electromagnetic induction scheme that charges a battery using an electromagnetic induction principle. According to the electromagnetic induction principle, a magnetic field is generated in a power transmitting end coil and electricity is induced in a receiving end coil due to the effect of the magnetic field. In this case, wireless power transmission standard of the electromagnetic induction scheme can include a wireless charging technology of electromagnetic induction scheme defined by WPC (Wireless Power Consortium) and/or PMA (Power Matters Alliance).

As a different example, a wireless power transmission scheme may use an electromagnetic resonance scheme. According to the electromagnetic resonance scheme, a magnetic field is generated by a transmitting coil of a wireless power transmitter, the generated magnetic field is tuned with a specific resonance frequency, and power is transmitted to a wireless power receiver located near the wireless power transmitter. For example, the electromagnetic resonance scheme can include a wireless charging technology of a resonance scheme defined by A4WP (Alliance for Wireless Power) corresponding to a wireless charging technology standard organization.

As a further different example, a wireless power transmission scheme may use an RF wireless power transmission scheme. According to the RF wireless power transmission scheme, energy of low power is loaded on an RF signal and power is transmitted to a wireless power receiver located at far using the RF signal.

According to a different example of the present invention, a wireless power transmitter can be designed to support at least two or more wireless power transmission schemes among the electromagnetic induction scheme, the electromagnetic resonance scheme, and the RF wireless power transmission scheme.

In this case, the wireless power transmitter can adaptively determine a wireless power transmission scheme to be used for a corresponding wireless power receiver based on not only a wireless power transmission scheme capable of being supported by the wireless power transmitter and the wireless power receiver, but also a type, a state, required power, and the like of the wireless power receiver.

According to one embodiment of the present invention, a wireless power receiver can include at least one wireless power transmission scheme and receive wireless power from two or more wireless power transmitters at the same time. In this case, the wireless power transmission scheme can include at least one selected from the group consisting of the electromagnetic induction scheme, the electromagnetic resonance scheme, and the RF wireless power transmission scheme.

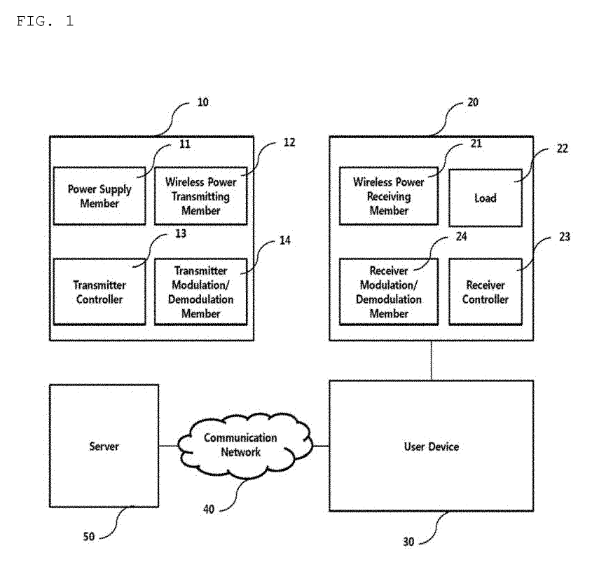

FIG. 1 is a diagram for a configuration of a wireless charging system according to one embodiment of the present invention.

Referring to FIG. 1, a wireless charging system can be configured by including a wireless power transmitter 10, a wireless power receiver 20, and a user device 30. According to one embodiment of the present invention, the wireless power receiver 20 can be configured in a manner of being included in the user device 30 as a unibody, by which the present invention may be non-limited. In this case, it is necessary to be cautious that the wireless power receiver can be interlocked with the user device via a separate wired/wireless communication means. For example, the user device 30 may correspond to a smartphone and the wireless power receiver 20 can be mounted on one side of a battery cover of the smartphone.

And, according to one embodiment of the present invention, the user device 30 can be interlocked with a server 50 via a communication network. For example, the user device 30 may download a prescribed wireless charging guide application providing a wireless charging coil alignment guide service from the server 50 and the wireless charging guide application can be installed in the user device 30. In this case, a user of the user device 30 can receive an alignment guide service via the wireless charging guide application to make the user device 30 to be placed on a precise charging area of the wireless power transmitter 10.

As a different embodiment, a configuration of providing the wireless charging coil alignment guide service can be embedded in a memory of the smartphone by default.

As a further different embodiment, a configuration of determining a coil alignment state can be mounted on the wireless power receiver 20 to provide the wireless charging coil alignment guide service. In this case, the wireless power receiver 20 determines a current coil alignment state based on various information internally collected by the wireless power receiver. In this case, the information includes information on output voltage strength of a rectifier, movement detection information, and the like. The wireless power receiver 20 may transmit the determined coil alignment state information to the user device 30. In this case, the coil alignment state information can include at least one selected from the group consisting of charging efficiency information, rectifier output voltage strength information, and location information of a transmitting coil. In the following, for clarity, assume that the wireless power receiver is included in the user device, by which the present invention may be non-limited.

According to one embodiment of the present invention, the user device 30 can acquire information on a position and a shape of a transmitting coil mounted on the wireless power transmitter 10 from the server 50.

According to one embodiment of the present invention, the user device 30 can receive at least one selected from the group consisting of location information (or information on an arrangement form) of a receiving coil mounted on the user device 30, information on a form of the receiving coil, and information on electrical characteristic of the receiving coil from the server 50.

In this case, the user device 30 identifies alignment states of the transmitting coil and the receiving coil using the location information and the information on the form of the transmitting coil mounted on the wireless power transmitter 10 and the location information and the information on the form of the receiving coil mounted on the user device 30. The user device 30 can output information on the identified alignment states through a screen mounted on the user device.

According to one embodiment of the present invention, the user device 30 can receive power state information (e.g., strength information of output voltage of a rectifier, strength information of voltage inputted to load, etc.), which is received from the wireless power transmitter, from the wireless power receiver 20. The user device 10 can identify an alignment state between the transmitting coil and the receiving coil based on the received power state information. The identified alignment state can be outputted via a screen mounted on the user device 30.

According to one embodiment of the present invention, the user device 30 can sense a movement of the user device 30 using a sensor (e.g., a geomagnetic sensor, an acceleration sensor, etc.) mounted on the user device 30. In this case, the user device 30 can determine a moving direction of the user device 30 based on a state change of power received according to the movement of the user device to enhance wireless charging efficiency. The user device 30 can display the determined moving direction on a screen via a prescribed direction indicator (e.g., arrow, etc.). In particular, a user moves the user device 30 according to the direction indicator displayed on the screen to precisely align the transmitting coil and the receiving coil.

According to one embodiment of the present invention, the user device 30 can also calculate a current charging efficiency based on power reception status information received from the wireless power receiver 20. The charging efficiency is calculated in real time and can be displayed on one side of the screen of the user device 30.

According to one embodiment of the present invention, if the calculated current charging efficiency is equal to or less than a prescribed reference value, the user device 30 can display a prescribed guide message on the screen to indicate a user to move the device on a charging pad. In this case, if the user moves the device, the user device 30 can forecast a location of the transmitting coil by measuring a reception power state change according to the movement. In this case, the user device 30 can display a prescribed guide message and/or a direction indicator on the screen to induce the user to move the device to the forecasted location.

According to one embodiment of the present invention, if a charging efficiency according to a movement of the device arrives at a prescribed reference value (e.g., 90% or higher), the user device 30 can display a prescribed guide message on the screen to indicate that device alignment has been successfully performed.

For example, the charging efficiency can be calculated by a percentage of a current rectifier output voltage value multiplied by a rectifier output current value to a rectifier maximum output power value.

As a different example, the charging efficiency can be calculated by a percentage of a power value applied to the transmitting coil of the wireless power transmitter 10 to a rectifier output power value of the wireless power receiver 20.

As a further different example, the charging efficiency can be calculated by a percentage of a power value requested to the wireless power transmitter 10 by the wireless power receiver 20 to an actually received power value.

As a further different example, the charging efficiency can be calculated by a percentage of a voltage value required by load to a voltage value practically applied to the load.

Referring to FIG. 1, the wireless power transmitter 10 can include a power supply member 11, a wireless power transmission member 12, a transmitter controller 13, and a transmitter modulation/demodulation member 14.

The wireless power transmission member 12 can transmit power permitted by the power supply member 11 in wireless via a transmitting coil mounted on the wireless power transmission member. In this case, the transmitting coil can include at least one of a transmission induction coil and a transmission resonance coil. The wireless power transmission member 12 can further include a prescribed frequency generator and/or a frequency modifier to transmit power of a specific frequency component. And, the wireless power transmission member 12 can further include a prescribed power control circuit to convert strength of AC power received from the power supply member 11.

The transmitter modulation/demodulation member 14 can include a modulator and a demodulator to exchange control information and/or status information with the wireless power receiver 20 in wireless. The transmitter modulation/demodulation member 14 modulates information received from the transmitter controller 13 and transmits the modulated information in wireless. Or, the transmitter modulation/demodulation member 14 demodulates information received from the transmitter controller 13 and forwards the demodulated information to the transmitter controller 13.

The transmitter controller 13 can control overall operation of the wireless power transmitter 10. For example, the transmitter controller 13 can adaptively control transmission power based on status information of the wireless power receiver 10. For example, the transmitter controller 13 controls strength of the transmission power based on status information of the wireless power receiver 10. If wireless charging is completed, the transmitter controller 13 can control the transmission power to be cut off.

The wireless power receiver 20 can include a wireless power reception member 21, a load 22, a receiver controller 23, and a receiver modulation/demodulation member 24.

The wireless power reception member 21 converts AC power applied via a receiving coil into DC power and forwards the DC power to the load 22. To this end, the wireless power reception member 21 can include at least one selected from the group consisting of a receiving coil configured to receive electromagnetic field, a rectifier configured to covert AC power into DC power, a DC-DC converter configured to convert rectified power into specific voltage required by the load 22, by which the present invention may be non-limited.

The receiver controller 23 senses a power reception status and/or internal failure/alarm status of the wireless power receiver 20 and may be able to transmit information on the sensed power reception status and/or internal failure/alarm status to the user device 30 and the wireless power transmitter 10.

In this case, information on the power reception status can include rectifier output voltage strength information, strength information of voltage applied to the load 22, and the like, by which the present invention may be non-limited. Information on the internal failure/alarm status can include overvoltage/overcurrent sensing information, overheating information, timer expiry information, charging completion information, and the like, by which the present invention may be non-limited.

The receiver modulation/demodulation member 24 can include a modulator and a demodulator to exchange control information and/or status information with the wireless power transmitter 10 in wireless. The receiver modulation/demodulation member 24 modulates information received from the receiver controller 23 and transmits the modulated information in wireless. Or, the receiver modulation/demodulation member 24 demodulates a received radio signal and forwards the demodulated signal to the receiver controller 23. When information is exchanged between the wireless power transmitter 10 and the wireless power receiver 20, it may use in-band communication scheme or out-of-band communication scheme. In this case, the in-band communication scheme corresponds to a scheme of exchanging various control signals and information using a frequency band identical to a frequency band used for wireless power transmission. The out-of-band communication scheme corresponds to a scheme of exchanging various control signals and information using a frequency band different from a frequency band used for wireless power transmission. For example, out-of-band communication may correspond to one selected from the group consisting of bi-directional Bluetooth communication, Wi-Fi communication, RFID communication, UWB communication, and infrared-ray communication, by which the present invention may be non-limited.

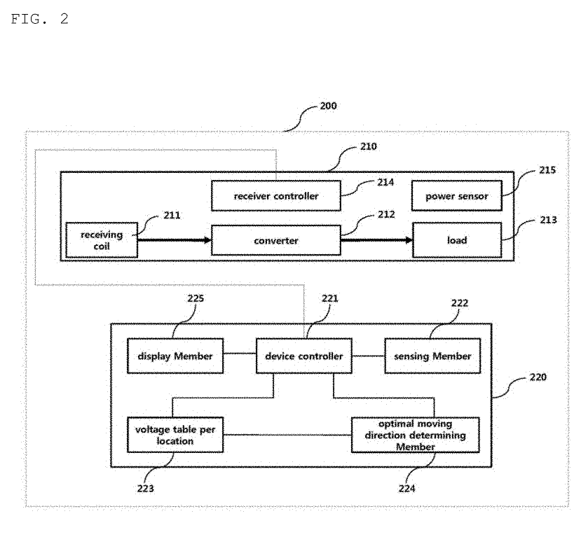

FIG. 2 is a block diagram for explaining a structure of a wireless charging device according to one embodiment of the present invention.

Referring to FIG. 2, a wireless charging device 200 can be mainly configured by a wireless power receiver 210 and a user device 220.

The wireless power receiver 210 can include a receiving coil 211, a converter 212 (or, a rectifier), a load 213, a receiver controller 214, and a power sensor 215. In this case, the load 213 is configured as a separate module and can be connected with the wireless power receiver 210 and the user device 220 via a prescribed interface terminal. The load 213 can provide power necessary for driving the user device 220.

The converter 212 rectifies AC power applied from the receiving coil 211, converts the AC power into DC power, and coverts the rectified DC power into strength (e.g., DC 5V) of power required by the load 213. In this case, the strength of the power may vary depending on a type and power consumption of the user device 220.

The power sensor 215 measures output voltage/current strength of the converter 212 (or, a rectifier) and can provide the measured value to the receiver controller 214. The power sensor may correspond to a circuit configuration capable of measuring voltage or strength of a current.

The receiver controller 214 can transmit received output voltage/current strength information to the user device 220.

In the following, an internal configuration of the user device 220 is explained in detail.

The user device 220 can include a device controller 221, a sensing member 222, a voltage table per location 223, an optimal moving direction determining member 224, a display member 225, and the like.

If reception of wireless power is sensed, the device controller 221 compares strength of output voltage of the converter 212 with a prescribed reference value to identify an alignment state of transmission/receiving coil.

When the alignment state is identified, if the alignment state of the transmission/receiving coil is not perfect, the device controller 221 generates a prescribed guide message to indicate a user to move the wireless charging device and can control the guide message to be displayed on the display member 225.

If the sensing member 222 senses a movement of the wireless charging device 200 according to the guide message, the sensing member can provide location information according to the movement to the device controller 221.

The device controller 221 maps strength of output voltage of the converter 212 according to a location and records the strength on the voltage table 223 per location.

The optimal moving direction determining member 224 determines an optimal moving direction of the wireless charging device 200 with reference to the voltage table per location 223 and can provide the determined optimal moving direction to the device controller 221. For example, the optimal moving direction can be determined in a form of a vector having a direction and a size. In this case, it is necessary to be cautious that the optimal moving direction determining member 224 and the voltage table per location 223 can be included in the device controller 221 in a software manner using a logical configuration without a separate hardware configuration. In this case, the device controller 221 can also determine an optimal moving direction with reference to the voltage table per location 223.

The device controller 221 can control a direction indicator corresponding to the determined optimal moving direction to be outputted via the display member 225. For example, the direction indicator may correspond to an arrow. An arrow direction is determined based on direction information of a vector corresponding to the optimal moving direction and a length of the arrow can be determined based on size information of the vector.

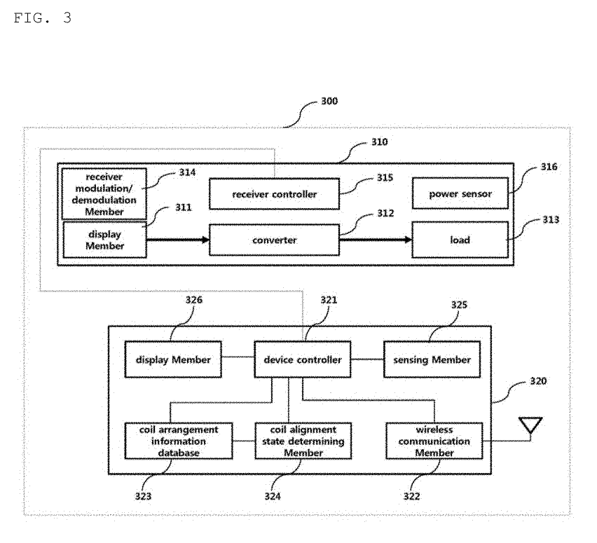

FIG. 3 is a block diagram for explaining a structure of a wireless charging device according to a different embodiment of the present invention.

Referring to FIG. 3, a wireless charging device 300 can be mainly configured by a wireless power receiver 310 and a user device 320.

The wireless power receiver 310 can include a receiving coil 311, a converter 312 (or, a rectifier), a load 313, a receiver modulation/demodulation member 314, a receiver controller 315, and a power sensor 316 (or, a voltage/current detecting circuit). In this case, the load 313 is configured as a separate module and can be connected with the wireless power receiver 310 and the user device 320 via a prescribed interface terminal. The load 313 can provide power necessary for driving the user device 320.

For operations and functions of the receiving coil 311, the converter 312, the load 313, the receiver controller 315, and the power sensor 316, it may refer to the description mentioned earlier in FIG. 2.

The receiver controller 315 can receive prescribed transmitter type information from the wireless power transmitter via the receiver modulation/demodulation member 314. The received transmitter type information can be transmitted to the device controller 321 of the user device 320. For example, the transmitter type information can be used as information for identifying a transmitter class of the wireless power transmitter, the number of transmitting coils mounted on the wireless power transmitter and a deployment form of the transmitting coils. In this case, the transmitter class can be used as a value for identifying strength of maximum output voltage, the number of receivers capable of being supported at the same time according to a category of the receivers, and the like.

For example, a class of a wireless power transmitter can be determined by comparing a maximum value of power (PTX_IN_COIL) applied to a transmitting coil with a maximum input power (PTX_IN_MAX) predefined according to a class shown in a wireless power transmitter class table (hereinafter, table 1). In this case, the PTX_IN_COIL may correspond to an average real number value which is calculated by dividing the multiplication of voltage (V(t)) and current (I(t)) applied to a transmitting coil during member time by the member time.

TABLE 1

| | | Requirement for | Maximum number |
|---|---|---|---|
| | | supporting | of devices |
| | Maximum input | minimum | capable of being |
| Class | power | category | supported |
| Class 1 | 2 W | 1 × Class 1 | 1 × Class 1 |
| Class 2 | 10 W | 1 × Class 3 | 2 × Class 2 |
| Class 3 | 16 W | 1 × Class 4 | 2 × Class 3 |
| Class 4 | 33 W | 1 × Class 5 | 3 × Class 3 |
| Class 5 | 50 W | 1 × Class 6 | 4 × Class 3 |
| Class 6 | 70 W | 1 × Class 6 | 5 × Class 3 |

The class shown in Table 1 is just an embodiment only. It may add or delete a new class. It is necessary to note that maximum input power according to a class, requirement for supporting minimum category, and the maximum number of devices capable of being supported may vary depending on a usage, a shape, and an implementation form of a wireless power transmitter.

As a first example, referring to Table 1, if a maximum value of power (PTX_IN_COIL) applied to a transmitting coil is equal to or greater than a PTX_IN_MAX value corresponding to the class 3 and is less than a PTX_IN_MAX value corresponding to the class 4, a class of a wireless power transmitter can be determined by the class 3.

As a second example, a wireless power transmitter can be identified according to a minimum category support requirements corresponding to an identified class.

In this case, the minimum category support requirements may correspond to the number of devices capable of being supported by a wireless power receiver corresponding to a category of a highest level among categories of the wireless power receiver supported by a wireless power transmitter of a corresponding class. In particular, the minimum category support requirements may correspond to the minimum number of maximum category devices capable of being supported by the wireless power transmitter. In this case, the wireless power transmitter can support wireless power receivers of all categories equal to or less that the maximum category according to the minimum category support requirements.

However, if the wireless power transmitter is able to support a wireless power receiver of a category higher than the category specified in the minimum category support requirements, it may not set a limit on a case that the wireless power transmitter supports the wireless power receiver.

For example, referring to Table 1, a wireless power transmitter of class 3 should support at least one wireless power receiver of category 5. Of course, the wireless power transmitter can support a wireless power receiver corresponding to a category of a level lower than a category level of the minimum category support requirements.

And, if it is determined that a wireless power transmitter is able to support a category of a level higher than the category level of the minimum category support requirements, it is necessary to be cautious that the wireless power transmitter is able to support a wireless power receiver having a category of a higher level as well.

As a third example, a wireless power transmitter can be identified by the maximum number of supportable devices corresponding to an identified class. In this case, the maximum number of supportable devices can be identified by the maximum number of devices (hereinafter, maximum number of devices capable of being supported) capable of being supported by a wireless power receiver corresponding to a category of a lowest level among categories capable of being supported in the identified class.

For example, referring to Table 1, a wireless power transmitter of class 3 should support maximum 2 wireless power receivers of which a minimum category corresponds to 3.

However, if a wireless power transmitter is able to support devices more than the maximum number of devices corresponding to a class of the wireless power transmitter, it may not set a limit on a case that the wireless power transmitter supports devices equal to or greater than the maximum number of devices.

According to the present invention, unless there is a special reason for not permitting a power transmission request of a wireless power receiver, it is necessary for a wireless power transmitter to perform wireless power transmission up to the number defined in Table 1 within available power.

For example, if the wireless power transmitter does not have available power as much as power for accepting the power transmission request, the wireless power transmitter may not accept the power transmission request of the wireless power receiver. Or, the wireless power transmitter can control power adjustment of the wireless power receiver.

As a different example, when the wireless power transmitter receives the power transmission request, if the number of wireless power receivers exceeds the number of wireless power receivers capable of being accepted by the wireless power transmitter, the wireless power transmitter may not accept the power transmission request of the wireless power receiver.

As a further different example, if a category of a wireless power receiver, which has requested power transmission, exceeds a level of a category capable of being supported in a class of a wireless power transmitter, the wireless power transmitter may not accept the power transmission request of the wireless power receiver.

As a further different example, if internal temperature of the wireless power transmitter exceeds a reference value, the wireless power transmitter may not accept the power transmission request of the wireless power receiver.

Referring to FIG. 3, the receiver controller 315 collects information on output voltage strength of the converter 312 sensed by the power sensor 316 and may transmit the information to the device controller 321. In this case, if converter 312 wireless power reception is sensed, the receiver controller 315 can transmit the information on the output voltage strength of the converter 312 to the device controller 321 with a prescribed interval.

The user device 320 can include a device controller 321, a wireless communication member 322, a coil arrangement information data base 323, a coil alignment state determining member 324, a sensing member 325, and a display member 326.

The device controller 321 receives coil arrangement information according to a type of a wireless power transmitter and a wireless power receiver (or, a wireless charging device) and may record the information in the coil arrangement information database 323. In this case, coil arrangement information of a transmitter includes size information of a charging bed, information on a size and a shape of a transmitting coil, arrangement form information of the transmitting coil, information on maximum output voltage strength of the transmitting coil, and the like, by which the present invention may be non-limited. And, coil arrangement information of a receiver can include at least one selected from the group consisting of size information of a screen of a display member, information on a size and a shape of a receiving coil, and information on an arrangement form of a coil mounted on a device.

According to one embodiment of the present invention, the device controller 321 and the coil alignment state determining member 324 can identify transmitter type information received from the wireless power receiver 310 and an arrangement form of transmission/receiving coils corresponding to a type of the wireless charging device 300 with reference to the coil arrangement information database 323.

In particular, according to the present invention, the coil alignment state determining member 324 determines an arrangement state of a transmitting coil and a receiving coil based on information on current converter output voltage strength and can transmit the determined coil alignment state information to the device controller 321.

And, the coil alignment state determining member 324 calculates charging efficiency corresponding to the current converter output voltage strength and can provide the calculated charging efficiency to the device controller 321.

And, the coil alignment state determining member 324 determines an optimal wireless charging device moving direction for maximizing charging efficiency (i.e., an optimal moving direction) in a current coil alignment state and can transmit the determined optimal moving direction to the device controller 321.

The device controller 321 configures a screen showing a current alignment state of a transmitting coil and a receiving coil (i.e., a coil arrangement screen) with reference to the determined coil alignment state information and the coil arrangement information database 323 and can provide the screen to the display member 326.

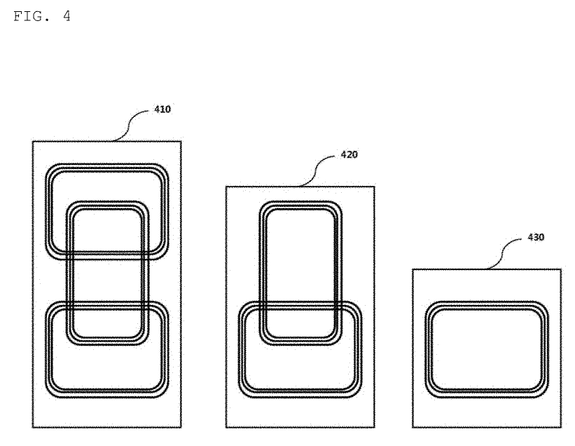

FIG. 4 is a diagram for explaining a transmitting coil arrangement structure of a wireless power transmitter according to one embodiment of the present invention.

Referring to FIG. 4, not only a size of a charging bed but also an arrangement form of a transmitting coil installed in the charging bed may vary depending on a type of a wireless power transmitter. As shown in FIG. 4, a wireless power transmitter may have such a coil arrangement form as three transmitting coils 410, two transmitting coils 420, one transmitting coil 430, and the like. Yet, this is just an embodiment only. It is necessary to note that a number/size/shape/arrangement form of a transmitting coil may vary depending on the usage and a configuration aspect of a wireless power transmitter.

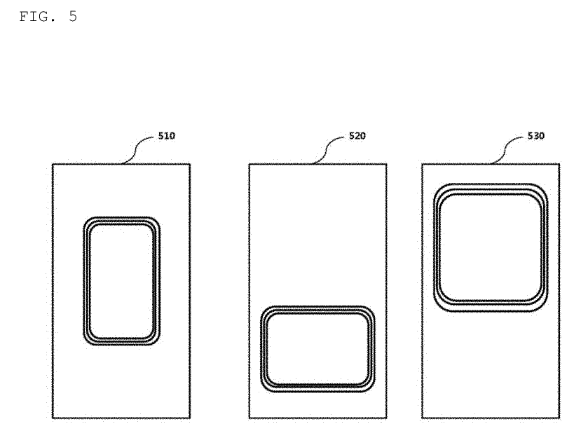

When a plurality of transmitting coils are deployed, as shown in drawing numbers 410 to 420, each of a plurality of the transmitting coils can be deployed in a manner of being partly overlapped each other. In this case, it is necessary to note that an area and a position where transmitting coils are overlapped may vary depending on the usage and a configuration aspect of a wireless power transmitter. FIG. 5 is a diagram for explaining a receiving coil arrangement structure of a wireless charging device according to one embodiment of the present invention.

As shown in drawing numbers 510, 520, and 530, a size/shape/arrangement form of a receiving coil mounted on a wireless charging device may vary depending on a type and a configuration aspect of the wireless charging device.

For example, referring to drawing number 510, a receiving coil can be mounted on the center of a wireless charging device. As a different example, a receiving coil can be mounted on the bottom of a wireless charging device. As a further different example, a receiving coil can be mounted on the top of a wireless charging device. The examples shown in drawing numbers 510 to 530 are just an embodiment only. It is necessary to note that a position on which a receiving coil is mounted may vary depending on a design of a wireless charging device. Although an example of mounting a single receiving coil on a wireless charging device has been explained in the foregoing embodiment, according to a different embodiment of the present invention, a plurality of coils can be mounted on a wireless charging device. In this case, it is necessary to note that a form of deploying a plurality of the receiving coils to the wireless charging device, a size and a shape of the receiving coils, electrical characteristic, and the like may vary depending on a type and a form of the wireless charging device. For example, a plurality of the receiving coils can be mounted on the wireless charging device in a manner of being partly or completely overlapped with each other. Or, a plurality of the receiving coils can be mounted on the wireless charging device in a manner of being separated from each other.

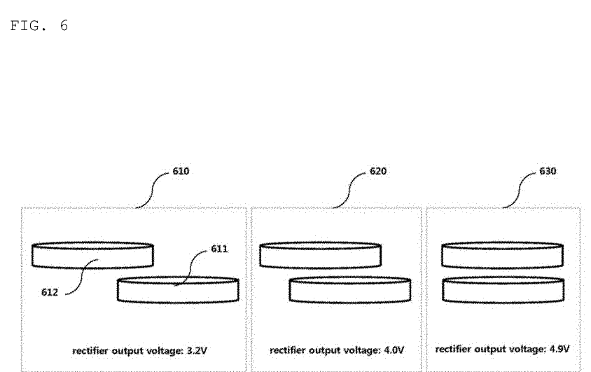

FIG. 6 is a diagram for explaining a change of output voltage of a rectifier according to the intensity of arrangement of a transmitting coil and a receiving coil according to one embodiment of the present invention.

As shown in drawing numbers 610 to 630 of FIG. 6, if a transmitting coil 611 and a receiving coil 612 are precisely aligned, it is able to see that strength of a rectifier output voltage increases. In particular, if a transmitting coil and a receiving coil are exactly aligned, as shown in the drawing number 630, charging efficiency can be relatively enhanced compared to the drawing number 610.

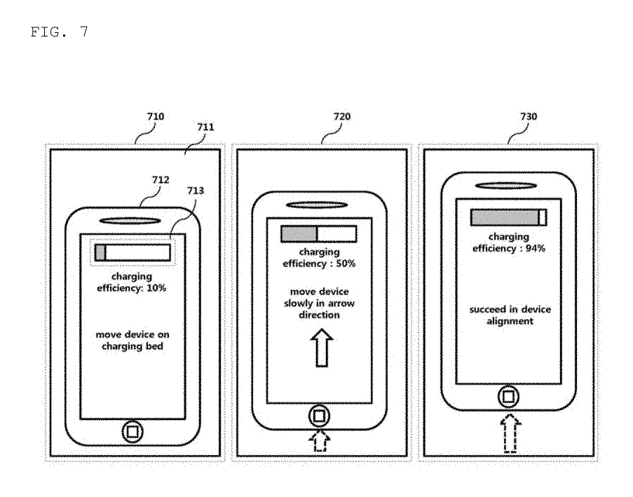

FIG. 7 is a diagram for explaining a method of guiding arrangement of a wireless charging device via a screen according to one embodiment of the present invention.

Referring to drawing number 710 of FIG. 7, if a wireless charging device 712 is put on a charging bed 711 and power reception is sensed in a wireless power receiver, information on current charging efficiency and a prescribed guide message for indicating a user to move the wireless charging device 712 on the charging bed 711 can be displayed on a screen 713 of the wireless charging device 712. In this case, the guide message can be displayed only when the current charging efficiency is equal to or less than a prescribed criterion. According to a different embodiment of the present invention, information on estimated time to be taken for completing charging of a load according to current charging efficiency, information on strength (or rectifier output voltage strength) of voltage currently applied to a load, and the like can be additionally displayed on one side of the screen 713 of the wireless charging device 712.

If a user moves the wireless charging device 712 on the charging bed 711 according to the guide message, as shown in drawing number 720, an optimal moving direction for aligning a transmitting coil with a receiving coil can be displayed on the screen of the wireless charging device.

If the user moves the wireless charging device 712 according to the displayed optimal moving direction, as shown in drawing number 730, a prescribed guide message indicating that device alignment is successfully performed can be displayed on the screen at a position where charging efficiency is equal to or greater than a prescribed reference varlue.

As a different embodiment, it may be able to guide a movement of a device of a user in various ways instead of the arrow shown in the drawing number 720. For example, if a central point of a transmitting coil is determined, it may be able to display an indicator capable of indicating a position corresponding to the central point. The indicator can be designed in various shapes. For example, the indicator can be designed by a shape corresponding to a shape of a transmitting coil. The indicator can differently display flashing depending on current charging efficiency. For example, if charging efficiency is highest according to a coil alignment state, the indicator may flicker with a minimum period (e.g., 0.1 second). If charging efficiency is lower, the indicator may flicker with a longer period. In this case, a device may display an indicator indicating a position of a receiving coil.

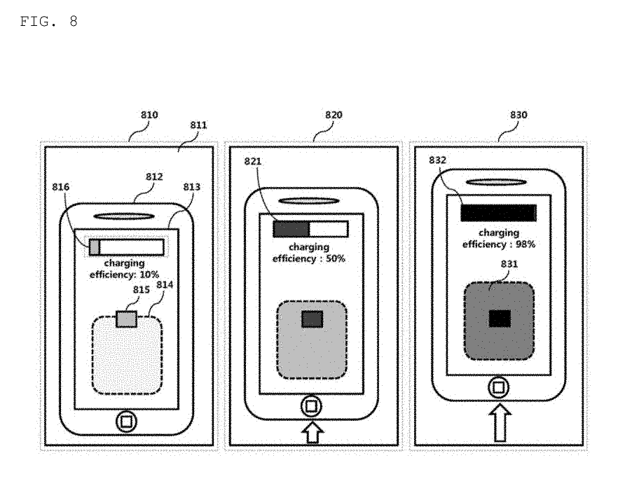

FIG. 8 is a diagram for explaining a method of guiding arrangement of a wireless charging device via a screen according to a different embodiment of the present invention.

Referring to drawing number 810 of FIG. 8, if a wireless charging device 812 (user device) is put on a charging bed 811 and power reception is sensed in a wireless power receiver, it may be able to display at least one selected from the group consisting of information on current charging efficiency, information on a current alignment state 814 of a receiving coil, and information on an alignment state of a transmitting coil on a screen 813 of the wireless charging device 812. As a different embodiment, it may be able to display a target point to which the wireless charging device moves to enhance charging efficiency on the screen 813 of the wireless charging device 812. The wireless charging device can identify at least one selected from the group consisting of information on a shape of a coil, information on an arrangement structure, and information on the number of coils based on coil type information and may be then able to display the identified information on the screen 813. Hence, it may have one or more target points where charging efficiency is enhanced. Or, it may display a target point where charging efficiency is highest only.

As a different embodiment, the wireless charging device can identify at least one selected from the group consisting of information on a shape of a receiving coil, information on an arrangement structure, and information on the number of coils and may be then able to display the identified information on the screen 813.

The receiver controller 214/315 mentioned earlier in FIGS. 2 to 3 can transmit the coil type information to the device controller 221/321.

When the device controller 221/321 senses wireless power reception or initially operates, the device controller asks the receiver controller 214/315 to transmit coil type information and obtains the coil type information. The device controller configures a prescribed coil arrangement state screen based on the obtained coil type information and can control the coil arrangement state screen to be outputted on the display member 326.

According to a different embodiment of the present invention, the device controller 221/321 can obtain transmitter type information from the receiver controller 214/315. The device controller accesses a prescribed server 50 via a wireless communication member 322 to acquire coil arrangement information corresponding to the obtained transmitter type information. Subsequently, the device controller configures a prescribed coil arrangement state screen based on the obtained coil arrangement information and can control the coil arrangement state screen to be outputted on the display member 326.

As shown in drawing numbers 820 and 830, a user can move the wireless charging device 812 on the charging bed 811 to make a transmitting coil 815 to be positioned at the center of a receiving coil 814 (i.e., to make wireless charging efficiency to be the highest) according to the displayed arrangement state information.

If charging efficiency becomes equal to or greater than a prescribed reference value according to the movement of the wireless charging device 812, as shown in drawing number 831, the wireless charging device 812 may be able to change a color of a prescribed region (e.g., a region of the receiving coil 814 or a region of the transmitting coil 815) of the screen or flicker the prescribed region with a prescribed period to indicate that coil alignment is completed. Yet, this is just an embodiment only. According to a different embodiment of the present invention, it may be able to inform a user of the completion of coil alignment via sound/vibration/lamp/message.

According to a different embodiment of the present invention, if charging efficiency is equal to or greater than a prescribed reference value, the wireless charging device 812 may display a prescribed notification on a screen to indicate that charging is available. For example, if the charging efficiency arrives at a first reference value, the wireless charging device 812 can control the transmitting coil 815 to flicker. If the charging efficiency is equal to or greater than a second reference value (in this case, the second reference value can be greater than the first reference value), the wireless charging device can control the transmitting coil 815 and the receiving coil 814 to flicker at the same time. As a different example, if charging efficiency arrives at a first reference value, the wireless charging device 812 can change a color of the transmitting coil 815. If the charging efficiency is equal to or greater than a second reference value (in this case, the second reference value can be greater than the first reference value), the wireless charging device can change both color of the transmitting coil 815 and color of the receiving coil 814.

According to a further different embodiment of the present invention, the wireless charging device 812 can control a flickering period of the transmitting coil 815 to be shorter according to the increase of the charging efficiency.

According to a further different embodiment of the present invention, the wireless charging device 812 can control an area on which the transmitting coil 815 and the receiving coil 814 are displayed to be widened according to the increase of the charging efficiency.

According to a further different embodiment of the present invention, as shown in drawing numbers 821 and 831, the wireless charging device 812 dynamically changes a color of a charging efficiency display bar 816 according to a change of the charging efficiency to enable a user to intuitively check a coil alignment state and information on whether or not charging is available.

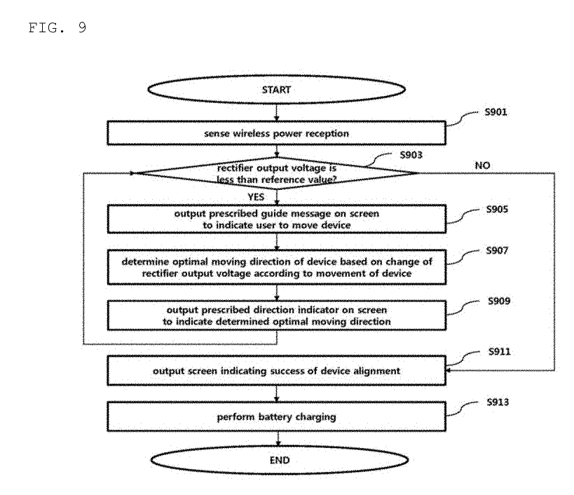

FIG. 9 is a flowchart for explaining a method of guiding arrangement of a wireless charging device in the wireless charging device according to one embodiment of the present invention.

Referring to FIG. 9, if wireless power reception is sensed, a wireless charging device can compare a rectifier output voltage with a prescribed reference value to determine whether or not the rectifier output voltage is smaller than the reference value [S901 to S903].

If the rectifier output voltage is smaller than the prescribed reference value, the wireless charging device can output a prescribed guide message on a screen to induce or indicate a user to move a device on a charging bed [S905].

The wireless charging device determines an optimal device moving direction for coil alignment based on a change of the rectifier output voltage according to the movement of the device and can output a prescribed direction indicator indicating the determined optimal moving direction on the screen [S907 to S909].

If a movement of the device is sensed according to the outputted direction indicator, the wireless charging device returns to the step 5903 and determines whether or not the rectifier output voltage arrives at the prescribed reference value by comparing the rectifier output voltage with the prescribed reference value.

If it is checked that the rectifier output voltage arrives at the prescribed reference value after the comparison, the wireless charging device outputs a prescribed guide message on the screen to indicate that device alignment is successfully performed and performs battery charging [S911 to S913].

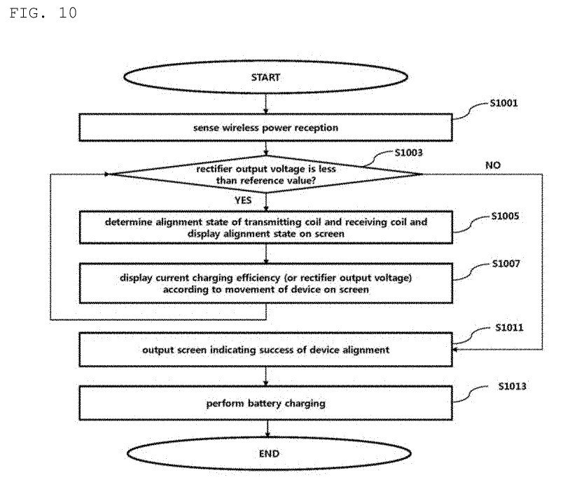

FIG. 10 is a flowchart for explaining a method of guiding arrangement of a wireless charging device in the wireless charging device according to a different embodiment of the present invention.

Referring to FIG. 10, if wireless power reception is sensed, a wireless charging device can compare a rectifier output voltage with a prescribed reference value to determine whether or not the rectifier output voltage is smaller than the reference value [S1001 to S1003].

If the rectifier output voltage is smaller than the prescribed reference value, the wireless charging device determines an alignment state of a receiving coil and a transmitting coil according to current rectified output voltage and can display the determined alignment state on a screen [S1005]. In this case, it is necessary to note that the reference value is differently configured according to a type of the wireless charging device or a category of a wireless power receiver mounted on the wireless charging device.

If a movement of a device is sensed, the wireless charging device calculates current charging efficiency and/or strength of the rectifier output voltage in real time according to the movement of the device and displays the charging efficiency and/or the strength of the rectifier output voltage on the screen [S1007].

The wireless charging device returns to the step S1003 and determines whether or not the rectifier output voltage arrives at the prescribed reference value by comparing the rectifier output voltage with the prescribed reference value in real time.

If it is checked that the rectifier output voltage arrives at the prescribed reference value after the comparison, the wireless charging device outputs a prescribed guide message on the screen to indicate that device alignment is successfully performed and performs battery charging [S1011 to S1013].

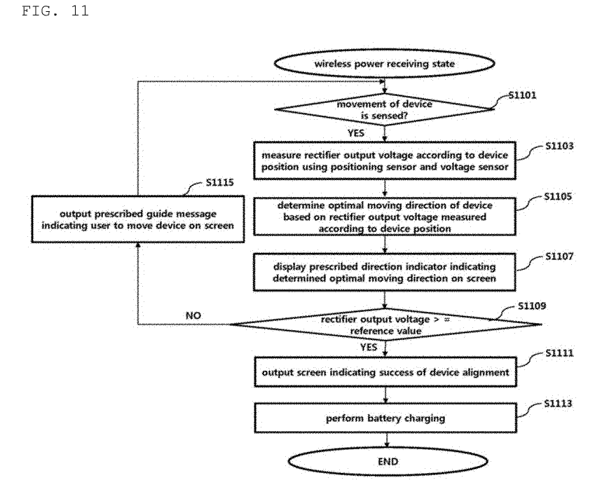

FIG. 11 is a flowchart for explaining a method of guiding arrangement of a wireless charging device in the wireless charging device according to a further different embodiment of the present invention.

Referring to FIG. 11, if a movement of a device is sensed in a wireless power receiving state, a wireless charging device can measure rectifier output voltage according to a position of the device using a positioning sensor (e.g., a geomagnetic sensor, an acceleration sensor, etc.) mounted on the wireless charging device and a voltage sensor [S1101 to S1103].

The wireless charging device determines an optimal device moving direction for coil alignment based on the rectifier output voltage measured according to a position of the device and can display a prescribed direction indicator indicating the determined optimal moving direction on the screen [S1105 to S1107].

If a movement of the device is sensed according to the displayed direction indicator, the wireless charging device can check whether or not the rectifier output voltage measured in real time is equal to or greater than a prescribed reference value.

If the rectifier output voltage is equal to or greater than the prescribed reference value, the wireless charging device configures a prescribed guide message or a prescribed screen indicating that device alignment is successfully performed, outputs the prescribed guide message or the prescribed screen on a screen, and can perform battery charging [S1113].

If it is determined that the rectifier output voltage is smaller than the prescribed reference value during prescribed time as a result of the step 51109, the wireless charging device can output a prescribed guide message on the screen to indicate a user to move the device [S1115].

It will be apparent to those skilled in the art that various modifications and variations can be made therein without departing from the spirit and scope of the invention.

Thus, the foregoing preferred embodiments of the present invention are merely exemplary and are not to be considered as limiting the present disclosure. Thus, the scope of the present invention can be determined by rational interpretation of the attached claims and it is intended that the present invention covers the modifications and variations of this invention that come within the scope of the appended claims and their equivalents.

### INDUSTRIAL APPLICABILITY

The present invention relates to a wireless charging technology and can be applied to a wireless charging device equipped with a wireless power receiver configured to receive wireless power from a wireless power transmitter.

What is claimed is:

1. A wireless charging device, comprising:
a receiving coil receiving power from a wireless power transmitter comprising a transmitting coil;
a power sensor configured to measure a strength of reception power if power reception is sensed via the receiving coil;
a coil alignment state determining member configured to determine a current alignment state of the transmitting coil and the receiving coil based on the strength of the measured power;
a device controller configured to generate a coil arrangement screen corresponding to the determined current alignment state; and
a display member configured to display the generated coil arrangement screen.

2. The wireless charging device of claim 1, further comprising a rectifier configured to convert AC power received via the receiving coil into DC power,
wherein the power sensor measures strength of output voltage of the rectifier.

3. The wireless charging device of claim 2, wherein if the strength of the output voltage of the rectifier is equal to or less than a prescribed reference value, the device controller controls a prescribed guide message indicating a movement of the wireless charging device to be displayed via the display member.

4. The wireless charging device of claim 1, further comprising:
a sensing member configured to sense a movement and a current position of the wireless charging device; and
an optimal moving direction determining member configured to determine an optimal moving direction of the wireless charging device to align the transmitting coil with the receiving coil based on a change of the strength of the reception power according to the movement.

5. The wireless charging device of claim 4, wherein the device controller controls a prescribed direction indicator indicating the determined optimal moving direction to be displayed on a side of a screen.

6. The wireless charging device of claim 4, wherein the device controller calculates charging efficiency corresponding to the strength of the reception power and controls at least one of the calculated charging efficiency and the strength of the reception power to be displayed on a side of a screen.

7. The wireless charging device of claim 1, further comprising:
a modulation/demodulation member configured to receive information for identifying a type of the wireless power transmitter; and
a coil arrangement information database configured to maintain arrangement form information of the transmitting coil according to a type of the wireless power transmitter.

8. The wireless charging device of claim 7, further comprising a wireless communication member configured to receive arrangement form information of the transmitting coil from a prescribed server according to the type of the wireless power transmitter.

9. The wireless charging device of claim 8, wherein the device controller receives arrangement form information of the receiving coil corresponding to the type of the wireless charging device from the server via the wireless communication member and stores the arrangement form information of the receiving coil in the coil arrangement information database.

10. The wireless charging device of claim 1, wherein if charging efficiency calculated according to the strength of the reception power is equal to or greater than a prescribed reference value, the device controller controls prescribed information indicating that the transmitting coil is successfully aligned with the receiving coil to be displayed on a screen.

11. A method of guiding alignment in a wireless charging device, comprising the steps of:
receiving power from a wireless power transmitter equipped comprising a transmitting coil;
measuring strength of reception power if power reception is sensed via the receiving coil,;
determining a current alignment state of the transmitting coil and the receiving coil based on the strength of the measured power; and
generating a coil arrangement screen corresponding to the determined current alignment state and displaying the coil arrangement screen on a screen.

12. The method of claim 11, further comprising the step of converting AC power received via the receiving coil into DC power,
wherein the strength of the reception power corresponds to strength of the converted DC power.

13. The method of claim 12, if the strength of the converted DC power is equal to or less than a prescribed reference value, further comprising the step of generating a prescribed guide message indicating a movement of the wireless charging device and displaying the prescribed guide message on the screen.

14. The method of claim 11, further comprising the steps of:
sensing a movement and a current position of the wireless charging device; and
determining an optimal moving direction of the wireless charging device to align the transmitting coil with the receiving coil based on a change of the strength of the reception power according to the movement.

15. The method of claim 14, wherein a prescribed direction indicator indicating the determined optimal moving direction is displayed on a side of the screen.

16. The method of claim 11, further comprising the step of calculating charging efficiency corresponding to the strength of the reception power,
wherein at least one of the calculated charging efficiency and the strength of the measured power is displayed on a side of the screen.

17. The method of claim 11, further comprising the steps of:
receiving prescribed transmitter type identification information from the wireless power transmitter; and
identifying a form of the transmitting coil arranged on a charging bed based on the transmitter type identification information.

18. The method of claim 8, further comprising the step of receiving arrangement form information of the receiving coil corresponding to the type of the wireless charging device from a prescribed server and storing the arrangement form information of the receiving coil in the coil arrangement information database.

19. The method of claim 11, if charging efficiency calculated according to the strength of the reception power is equal to or greater than a prescribed reference value, further comprising the step of displaying prescribed information indicating that the transmitting coil is successfully aligned with the receiving coil on a side of the screen.

20. A method of guiding alignment in a wireless charging device configured to receive power from a wireless power transmitter equipped with a transmitting coil via a receiving coil, comprising the steps of:
if power reception is sensed via the receiving coil, measuring strength of rectifier output power;
if the measured strength of the rectifier output power is equal to or less than a prescribed reference value, determining an optimal moving direction of the wireless charging device based on a change of the strength of the rectifier output power according to a movement of the wireless charging device; and
displaying the determined optimal moving direction on a screen.
